(19) United States
(12) Patent Application Publication
(10) Pub. No.: US 2025/0183928 A1
(43) Pub. Date: Jun. 5, 2025

(54) ARTIFICIAL INTELLIGENCE-BASED CALIBRATION OF DISTORTION COMPENSATION

(71) Applicant: Qualcomm Incorporated, San Diego, CA (US)

(72) Inventors: Kalpant PATHAK, Bangalore (IN); Kapil BHATTAD, Bangalore (IN); Santanu PATTANAYAK, Bangalore (IN); Gautham HARIHARAN, Sunnyvale, CA (US); Supratik BHATTACHARJEE, San Diego, CA (US)

(21) Appl. No.: 18/527,175

(22) Filed: Dec. 1, 2023

(51) Int. Cl. H04B 1/10; H04B 1/04; H04L 41/16; H04W 24/02

(52) U.S. Cl. CPC H04B 1/10; H04B 1/0475; H04L 41/16; H04W 24/02

(57) ABSTRACT

Certain aspects of the present disclosure provide techniques for artificial intelligence based calibration of distortion compensation for radio frequency chain circuitry. An example method for wireless communications includes providing, to at least one artificial intelligence (AI) model, first input based at least in part on at least one output signal corresponding to at least one calibration signal having one or more tones in a frequency bandwidth. The method further includes obtaining, from the at least one AI model, first output comprising an indication of one or more filter parameters configured to suppress distortion in the frequency bandwidth. The method further includes storing the one or more filter parameters in one or more memories.

### INTRODUCTION

Aspects of the present disclosure relate to wireless communications, and more particularly, to techniques for radio frequency (RF) circuit distortion compensation.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Some aspects provide a method for wireless communications at a wireless device. The method includes providing, to at least one artificial intelligence (AI) model, first input based at least in part on at least one output signal corresponding to at least one calibration signal having one or more tones in a frequency bandwidth. The method further includes obtaining, from the at least one AI model, first output comprising an indication of one or more filter parameters configured to suppress distortion in the frequency bandwidth. The method further includes storing the one or more filter parameters in one or more memories.

Some aspects provide an apparatus configured for wireless communications at a wireless device. The apparatus includes one or more memories and one or more processors coupled to the one or more memories. The one or more processors are configured to cause the wireless device to provide, to at least one artificial intelligence (AI) model, first input based at least in part on at least one output signal corresponding to at least one calibration signal having one or more tones in a frequency bandwidth; obtain, from the at least one AI model, first output comprising an indication of one or more filter parameters configured to suppress distortion in the frequency bandwidth; and store the one or more filter parameters in the one or more memories.

Some aspects provide an apparatus configured for wireless communications at a wireless device. The apparatus includes means for providing, to at least one artificial intelligence (AI) model, first input based at least in part on at least one output signal corresponding to at least one calibration signal having one or more tones in a frequency bandwidth. The apparatus further includes means for obtaining, from the at least one AI model, first output comprising an indication of one or more filter parameters configured to suppress distortion in the frequency bandwidth. The apparatus further includes means for storing the one or more filter parameters in one or more memories.

Some aspects provide a non-transitory computer-readable medium. The computer-readable medium has instructions stored thereon, that when executed by an apparatus, cause the apparatus to perform a method. The method includes providing, to at least one artificial intelligence (AI) model, first input based at least in part on at least one output signal corresponding to at least one calibration signal having one or more tones in a frequency bandwidth. The method further includes obtaining, from the at least one AI model, first output comprising an indication of one or more filter parameters configured to suppress distortion in the frequency bandwidth. The method further includes storing the one or more filter parameters in one or more memories.

Some aspects provide a method of manufacturing an apparatus for wireless communications. The method includes obtaining the apparatus, the apparatus comprising one or more memories storing at least one artificial intelligence (AI) model trained to predict one or more filter parameters, and one or more processors coupled to the one or more memories, the one or more processors being configured to filter one or more communication signals using a filter in accordance with the one or more filter parameters. The method further includes providing, to the at least one AI model, first input based at least in part on at least one output signal corresponding to at least one calibration signal having one or more tones in a frequency bandwidth. The method further includes obtaining, from the at least one AI model, first output comprising an indication of one or more filter parameters configured to suppress distortion in the frequency bandwidth. The method further includes storing the one or more filter parameters in the one or more memories.

Some aspects provide a system for manufacturing an apparatus for wireless communications. The system includes one or more first memories and one or more first processors coupled to the one or more first memories. The one or more first processors are configured to cause the system to obtain the apparatus, the apparatus comprising one or more second memories storing at least one artificial intelligence (AI) model trained to predict one or more filter parameters, and one or more second processors coupled to the one or more memories, the one or more second processors being configured to filter one or more communication signals using a filter in accordance with the one or more filter parameters. The one or more first processors are configured to cause the system to provide, to the at least one AI model, first input based at least in part on at least one output signal corresponding to at least one calibration signal having one or more tones in a frequency bandwidth. The one or more first processors are configured to cause the system to obtain, from the at least one AI model, first output comprising an indication of one or more filter parameters configured to suppress distortion in the frequency bandwidth. The one or more first processors are configured to cause the system to store the one or more filter parameters in the one or more second memories.

Some aspects provide a system for manufacturing an apparatus for wireless communications. The system includes means for obtaining the apparatus, the apparatus comprising means for storing at least one artificial intelligence (AI) model trained to predict one or more filter parameters, and means for filtering one or more communication signals using a filter in accordance with the one or more filter parameters. The system further includes means for providing, to the at least one AI model, first input based at least in part on at least one output signal corresponding to at least one calibration signal having one or more tones in a frequency bandwidth. The system further includes means for obtaining, from the at least one AI model, first output comprising an indication of one or more filter parameters configured to suppress distortion in the frequency bandwidth. The system further includes means for storing the one or more filter parameters in the one or more memories.

Some aspects provide a non-transitory computer-readable medium. The computer-readable medium has instructions stored thereon, that when executed by a system for manufacturing an apparatus for wireless communications, cause the system to perform a method. The method includes obtaining an apparatus, the apparatus comprising one or more memories storing at least one artificial intelligence (AI) model trained to predict one or more filter parameters, and one or more processors coupled to the one or more memories, the one or more processors being configured to filter one or more communication signals using a filter in accordance with the one or more filter parameters. The method further includes providing, to the at least one AI model, first input based at least in part on at least one output signal corresponding to at least one calibration signal having one or more tones in a frequency bandwidth. The method further includes obtaining, from the at least one AI model, first output comprising an indication of one or more filter parameters configured to suppress distortion in the frequency bandwidth. The method further includes storing the one or more filter parameters in the one or more memories.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 illustrates an example artificial intelligence (AI) architecture that may be used for AI-enhanced wireless communications.

FIG. 6 illustrates an example AI architecture of a first wireless device that is in communication with a second wireless device.

FIG. 7 illustrates an example artificial neural network.

FIG. 8 illustrates an example receiver architecture that performs distortion compensation.

FIG. 9A illustrates an example AI model for calibrating or configuring distortion compensation.

FIG. 9B illustrates an example neural network for calibrating or configuring distortion compensation.

FIG. 10A illustrates example operations for training an AI model to calibrate or configure distortion compensation.

FIG. 10B illustrates an example of a model training host that trains an AI model.

FIG. 11 illustrates example operations for calibrating or configuring distortion compensation using multiple neural networks.

FIG. 12 illustrates example operations for manufacturing a wireless communications device that performs distortion compensation.

FIG. 13 depicts a method for wireless communications.

FIG. 14 depicts another method for wireless communications.

FIG. 15 depicts aspects of an example communications device.

### DETAILED DESCRIPTION

Aspects of the present disclosure provide apparatuses, methods, processing systems, and computer-readable mediums for artificial intelligence (AI) based calibration of distortion compensation for radio frequency (RF) chain circuitry.

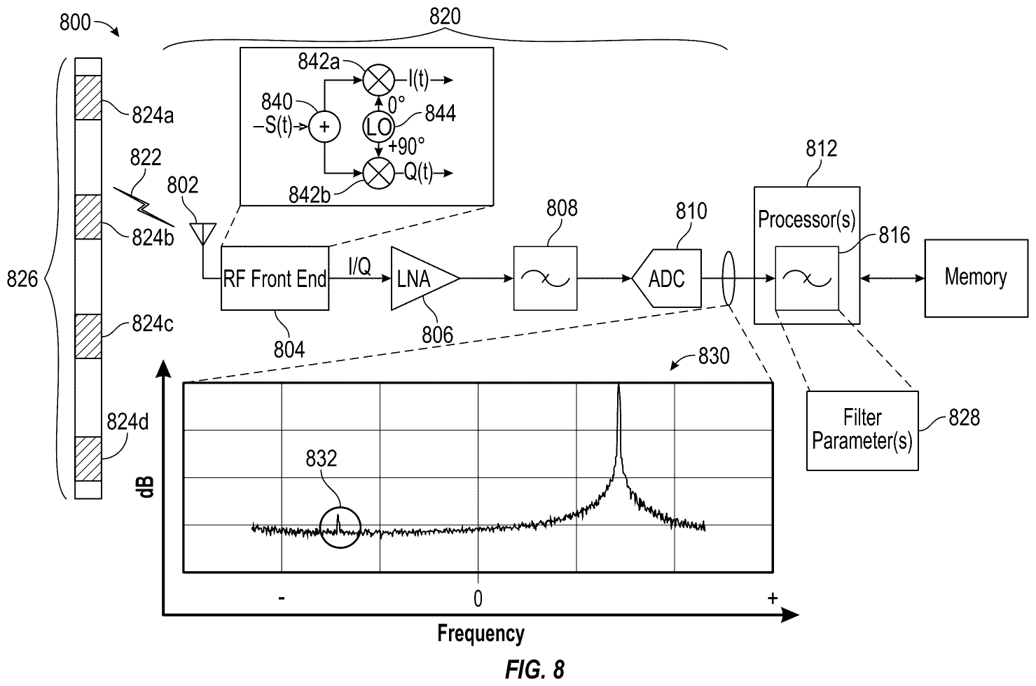

Certain wireless communications devices employ analog RF chain circuitry (e.g., mixers, filters, amplifiers, duplexers, diplexers, antenna tuners, etc.) to communicate via radio waves. In some cases, the RF chain circuitry may use multiple signal paths for modulation. For example, RF chain circuitry that performs quadrature modulation (e.g., quadrature phase-shift keying (QPSK) or quadrature amplitude modulation (QAM)) may have in-phase (I) and quadrature-phase (Q) signal paths. The in-phase/quadrature (I/Q) signal paths carry two signals that are in quadrature phase, e.g., a phase offset of one-quarter cycle (90 degrees or π/2 radians), for example, as depicted in FIG. 8. For each of the I/Q signal paths, the RF chain circuitry may have a separate cascade of analog circuits, for example, filters, mixers, amplifiers, etc.

In some cases, modulation signal paths (e.g., I/Q signal paths) may impart different effects (e.g., gain and/or phase offsets) on the respective signals, for example, due to filters and/or mixers in the signal paths not being identical hardware components between the parallel signal paths. As a result, the phase difference between the I/Q components may not be exactly 90 degrees (or any other suitable phase offset between the parallel signal paths), and the gain of the I/Q components may not be perfectly matched between the parallel sections of circuitry dealing with the I/Q signal paths. For example, a transfer function of the in-phase signal path H_{I}(ω) may not be equal to the transfer function of the quadrature signal path H_{Q}(ω) (e.g., H_{I}(ω)≠H_{Q}(ω)) due to different mixers being used in each of the signal paths. Such an imbalance between the I/Q signal paths may be referred to as an I/Q imbalance. The I/Q imbalance can cause distortion (e.g., phase and gain errors) on communication signals. As an example with respect to distortion on a receive chain, the I/Q imbalance can cause residual sidebands (for example, outside the baseband frequency) to form in the digital baseband signal, which may affect the demodulation performance of the received signal.

As the distortion may be specific to the hardware in the RF chain circuitry, a wireless communications device may perform distortion compensation. The distortion compensation may be determined through a device calibration process, for example, as a part of manufacturing the device. During the calibration process, a calibration signal having one or more training tones may be applied to the RF chain circuitry to measure the distortion caused by the RF chain circuitry. A digital filter may be used to suppress the distortion encountered due to I/Q imbalance in the RF chain circuitry. As an example, an N-tap finite impulse response (FIR) filter may be used to suppress the residual sideband distortion of a receive chain. Filter coefficients for the FIR filter may be determined during device calibration. The filter coefficients may be determined using a technique that minimizes the distortion (e.g., the residual sideband energy) at or caused by the training tones of the calibration signal in an operating bandwidth. The filter may be configured to have a particular number of taps, which may define the total number of coefficients and delays of an FIR filter. The filter coefficients may be stored in memory on the wireless device and used to suppress or cancel distortion in communication signals.

In some cases, such a calibration technique is performed in a non-trivial amount of time. For example, the filter coefficients may be determined for multiple operating scenarios, for example, for each combination of bandwidth, analog to digital conversion (ADC) rate, and/or filtering mode (e.g., a half-band filtering mode, normal filtering mode, etc.). Each of the operating scenarios may take a certain amount of time to calibrate the distortion compensation.

In certain cases, the calibration technique may only be capable of minimizing the distortion encountered for the training tones of the calibration signal in each of the frequency bandwidths calibrated. Some of the filter coefficients may allow some distortion to pass at or caused by other frequencies in a frequency bandwidth of a respective calibration signal due to the filter coefficients being configured to minimize the distortion at or caused by the training tones. In other words, the training tones of a calibration signal may provide a partial characterization of the distortion encountered at a frequency bandwidth.

In some cases, the calibration technique may provide filter configurations that provide a common level of performance for multiple distortion compensation scenarios (e.g., different bandwidths, filtering modes, etc.). In certain scenarios (e.g., a specific bandwidth and/or filtering mode), the distortion may be compensated with fewer filter taps than what is enabled by the calibration technique, as the calibration technique may apply a specific number of filter taps for multiple scenarios regardless of the actual level of distortion at a particular scenario. For example, the distortion could be adequately compensated with a two-tap filter at a certain bandwidth, but the calibration technique may determine the filter coefficients of a four-tap filter for that bandwidth and likewise for other bandwidths. As the taps of a digital FIR filter affect its performance (e.g., power consumption, processing latency, memory usage, processor usage, etc.), the filter taps enabled by the calibration technique may provide the same level of performance across multiple compensation scenarios despite there being a suitable FIR filter with fewer taps for at least one of the scenarios.

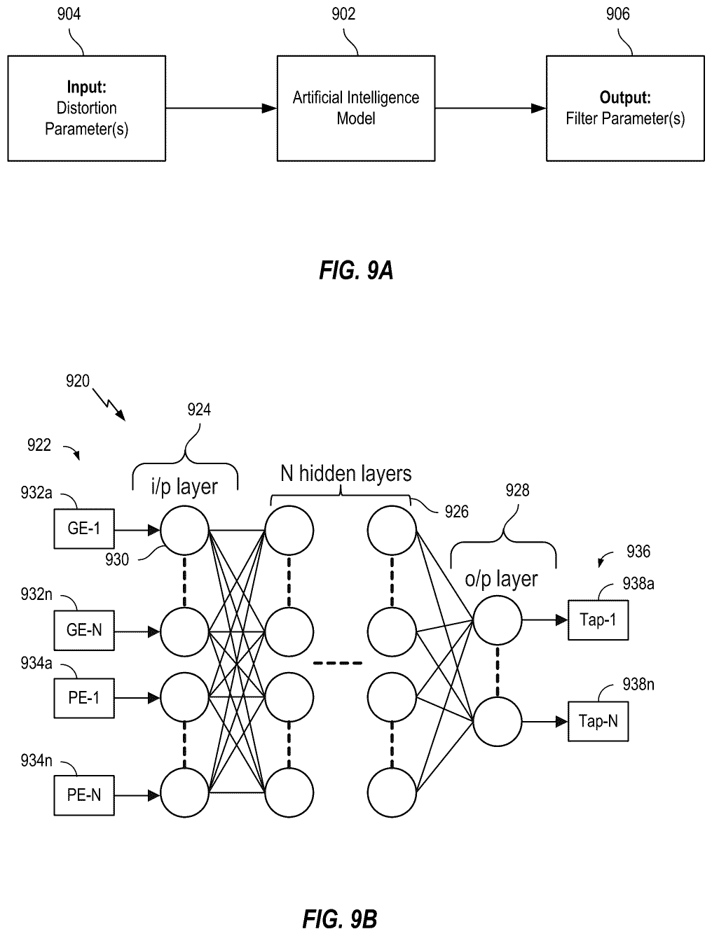

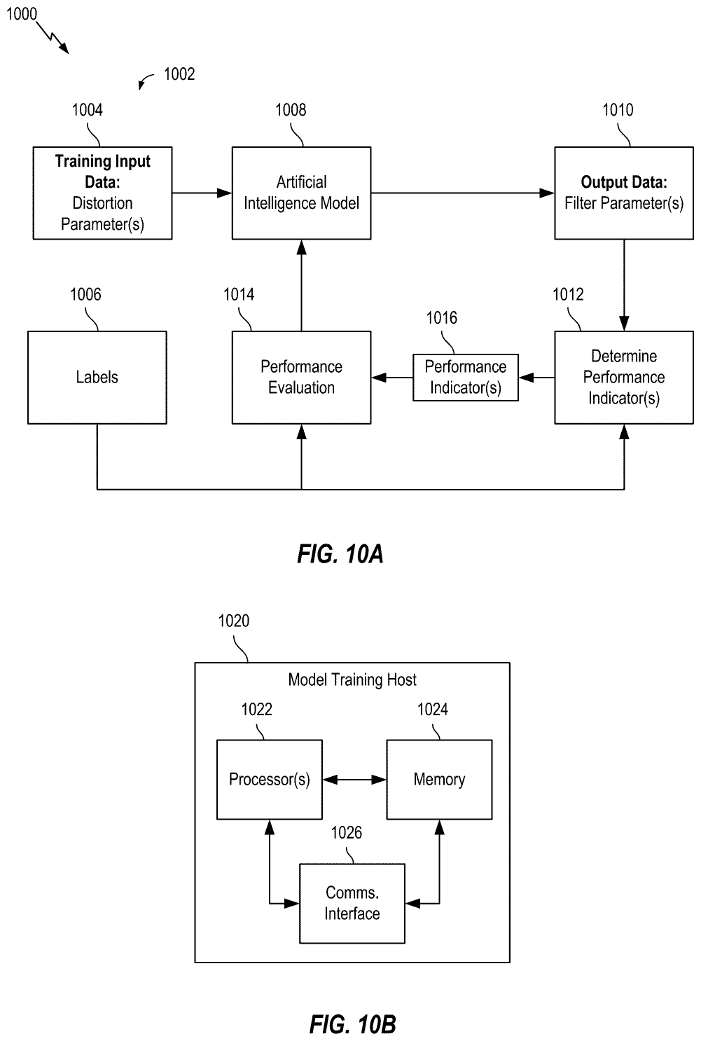

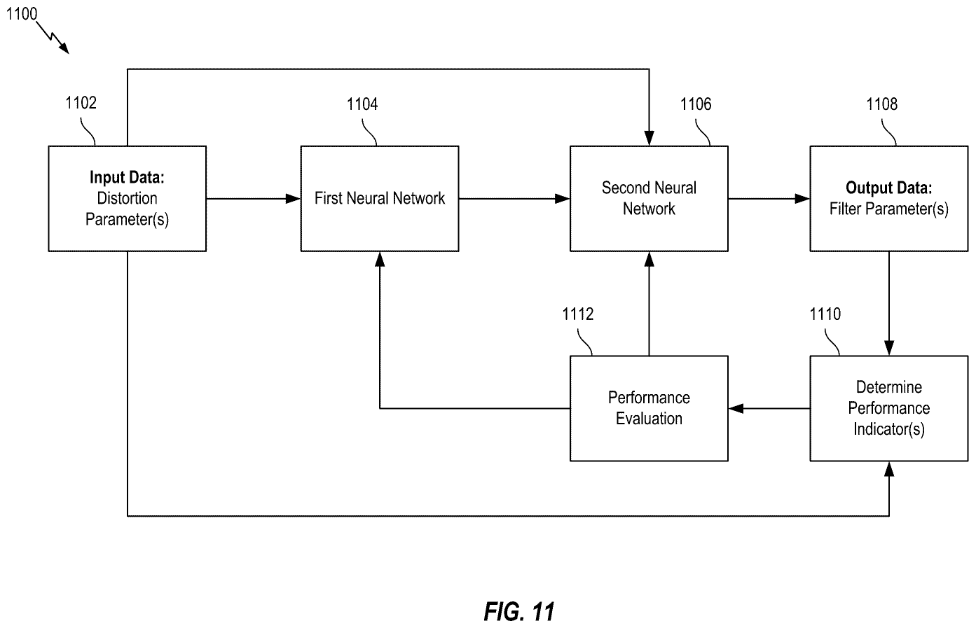

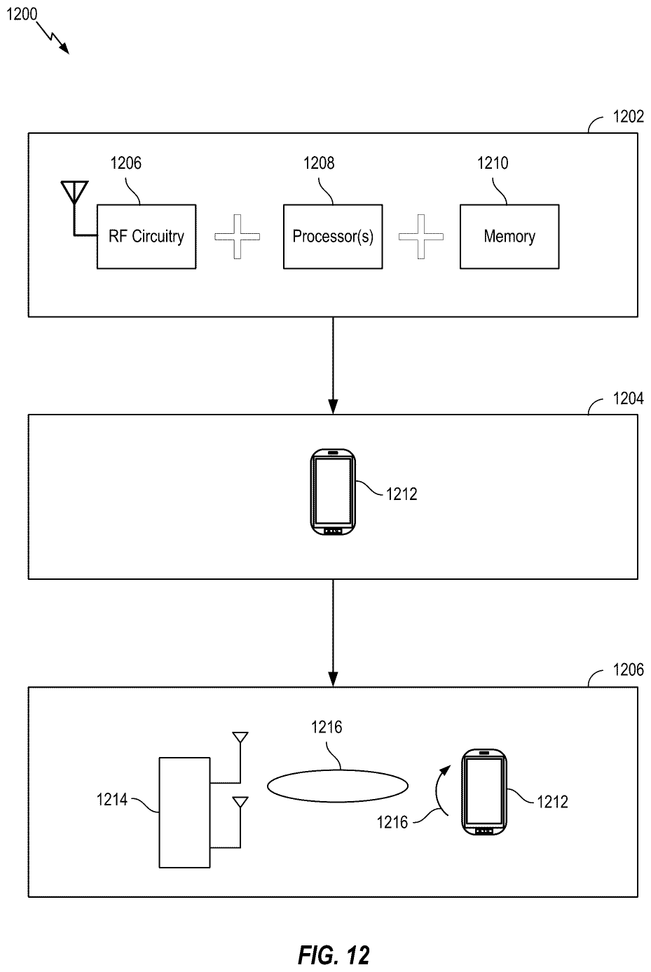

Aspects described herein provide AI-based calibration of distortion compensation for RF chain circuitry. An AI model may be trained to predict filter parameters for a filter (e.g., an FIR filter) configured to suppress distortion (e.g., a frequency dependent residual sideband) associated with the RF chain circuitry, for example, as described herein with respect to FIGS. 9A and 9B. In certain aspects, the AI model may obtain input that is indicative of the distortion in a specific frequency bandwidth, and the AI model may output the predicted filter parameters, such as the number of taps, the filter coefficients, etc. As an example, the input may include one or more gain errors and/or one or more phase errors introduced by the RF chain circuitry at one or more training tones in the frequency bandwidth. In certain aspects, the AI model may be trained with training data representative of the distortion at supplemental training tones across a frequency bandwidth and/or obtained from multiple wireless devices with various distortions, for example, as described herein with respect to FIG. 10. In certain aspects, another AI model may be used to predict the training tones to use for the calibration signal, for example, as described herein with respect to FIG. 11. The other AI model may output predicted training tones that provide a specific representation of the distortion across the frequency bandwidth (e.g., the strongest distortion). In certain aspects, the AI-based calibration technique may be implemented as a part of manufacturing a wireless communication device, for example, as described herein with respect to FIG. 12.

The techniques for AI-based calibration of distortion compensation as described herein may provide various enhancements and/or improvements. The techniques for AI-based calibration of distortion compensation may enable improved distortion compensation, for example, by providing filter parameters that minimize an average distortion (and/or other suitable metrics) across a frequency bandwidth. Thus, the AI derived filter parameters may suppress or cancel distortion at other frequencies than the distortion observed via the training tones.

In certain aspects, the improved distortion compensation may be attributable to the AI model training. For example, the AI model may be trained on distortion data at supplemental training tones and/or from multiple wireless devices with various distortions and/or RF chain circuitry architectures. Such AI model training may allow the AI model to predict filter parameters that minimize an average distortion (and/or other distortion metric) across the frequency bandwidth rather than only suppressing the distortion at or caused by training tones used during the calibration process. The AI model may be able to predict such filter parameters using input indicative of the distortion at a small number of training tones compared to the training data of the AI model, for example, as further described herein with respect to FIG. 10A. Expressed another way, the AI model may effectively have knowledge of the average distortion (and/or other metric(s)) given a small number of training tones to enable suppression of the average distortion without applying dozens of training tones to characterize the distortion and determine the average distortion. Thus, the techniques for AI-based calibration of distortion compensation may be capable of providing the improved distortion compensation without increasing the duration of the calibration process, for example, by applying dozens of training tones that fully characterize the distortion.

The techniques for AI-based calibration of distortion compensation may enable improved performance of the distortion compensation. For example, the AI-based calibration may provide fewer filter taps in certain cases (e.g., where the distortion associated with a particular frequency bandwidth is small and/or can be suppressed with few filter taps), and the fewer filter taps of a filter may allow for reduced power consumption, processing latency, memory usage, processor usage, etc. associated with such filter.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

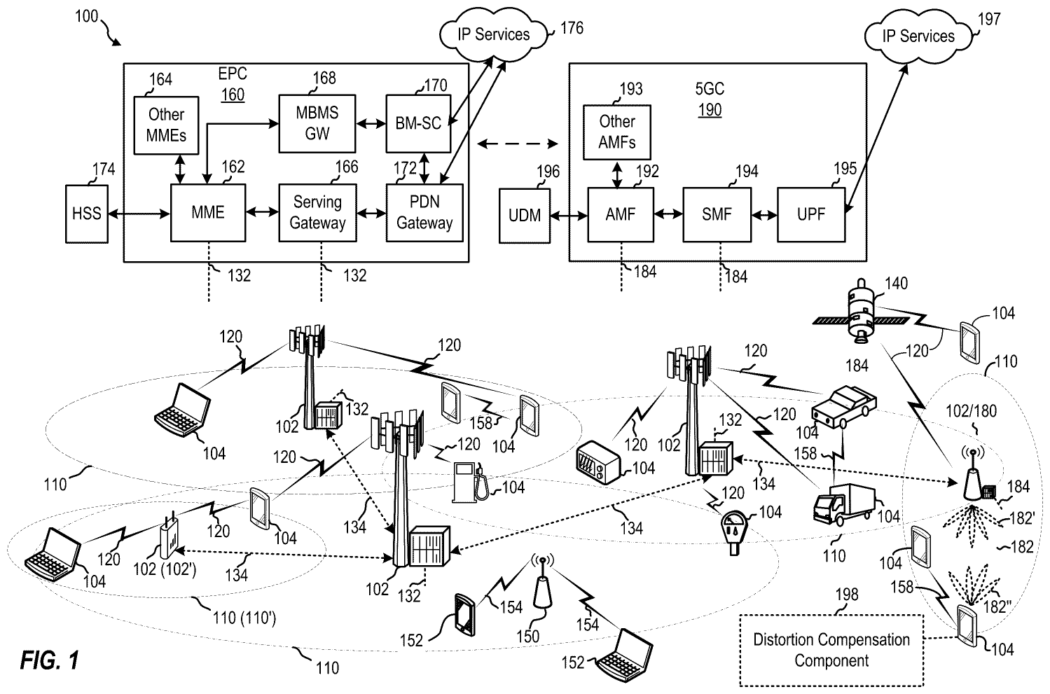

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

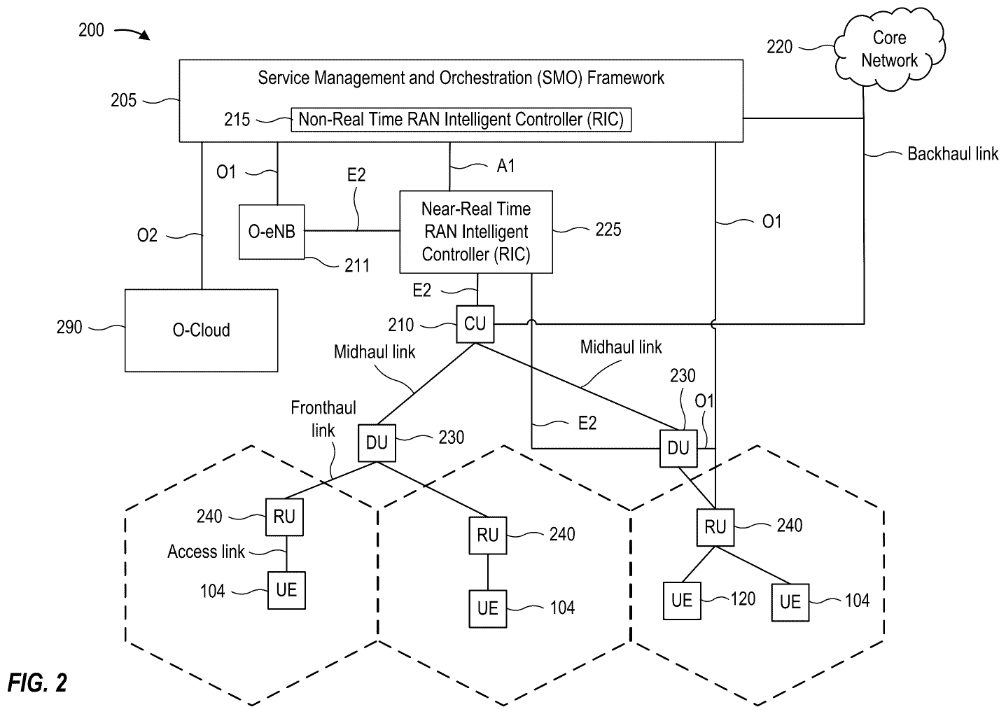

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

Wireless communications network 100 includes a distortion compensation component 198, which may be used configured to calibrate distortion compensation using artificial intelligence and/or suppress or compensate distortion associated with RF chain circuitry as further described herein.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

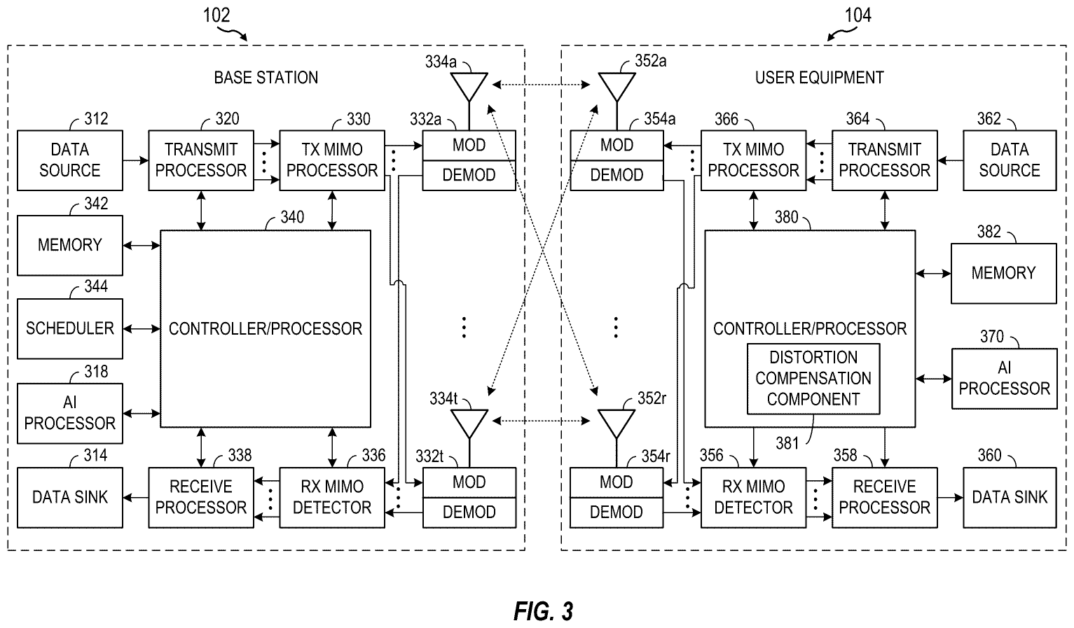

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform distortion compensation calibration (as further described herein), AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

In the depicted example, controller/processor 380 includes a distortion compensation component 381, which may be representative of the distortion compensation component 198 of FIG. 1. Notably, while depicted as an aspect of controller/processor 380, the distortion compensation component 381 may be implemented additionally or alternatively in various other aspects of user equipment 104 in other implementations.

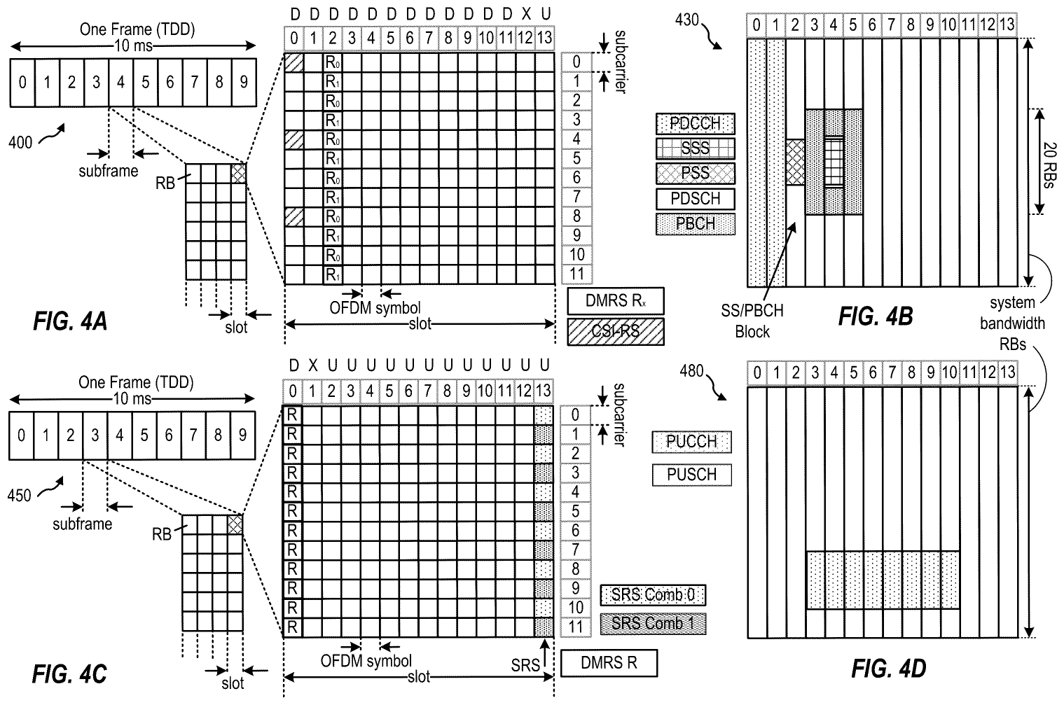

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN or machine learning. An ML model may be an example of an AI model, and other AI models may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

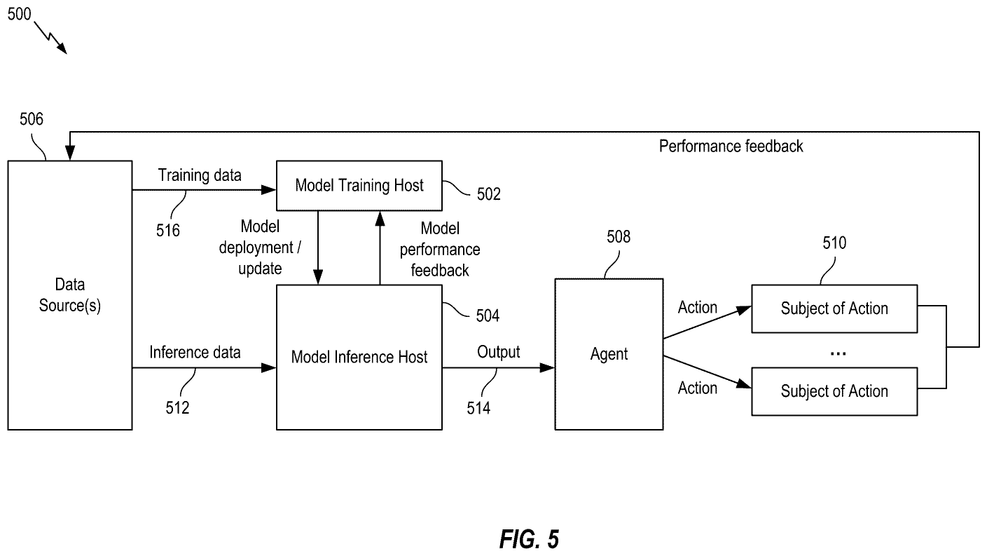

FIG. 5 is a diagram illustrating an example AI architecture 500 that may be used for AI-enhanced wireless communications. As illustrated, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508.

The agent 508 may be an element or an entity of a wireless communication system including, for example, a radio access network (RAN), a wireless local area network, a device-to-device (D2D) communications system, etc. As an example, the agent 508 may be a user equipment (UE), a base station or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a DU or an RU and the output from model inference host 504 is associated with beam management, the agent 508 may determine whether to change or modify a transmit and/or receive beam based on the output 514. If the agent 508 determines to act based on the output 514, agent 508 may indicate the action to at least one subject of the action 510. For example, if the agent 508 determines to change or modify a transmit and/or receive beam for a communication between the agent 508 and the subject of action 510 (e.g., a UE), the agent 508 may send a beam switching indication to the subject of action 510 (e.g., a UE). As another example, the agent 508 may be a UE, the output 514 from model inference host 504 may be one or more predicted channel characteristics for one or more beams. For example, the model inference host 504 may predict channel characteristics for a set of beams based on the measurements of another set of beams. Based on the predicted channel characteristics, the agent 508, such as the UE, may send, to the subject of action 510, such as a BS, a request to switch to a different beam for communications. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, an AI model is deployed at or on a UE for calibration of distortion compensation associated with RF chain circuitry. More specifically, a model inference host, such as model inference host 504 in FIG. 5, may be deployed at or on the UE for predicting filter parameters used for distortion compensation, such as residual sideband distortion from an in-phase/quadrature imbalance, as further described herein with respect to FIGS. 8-12.

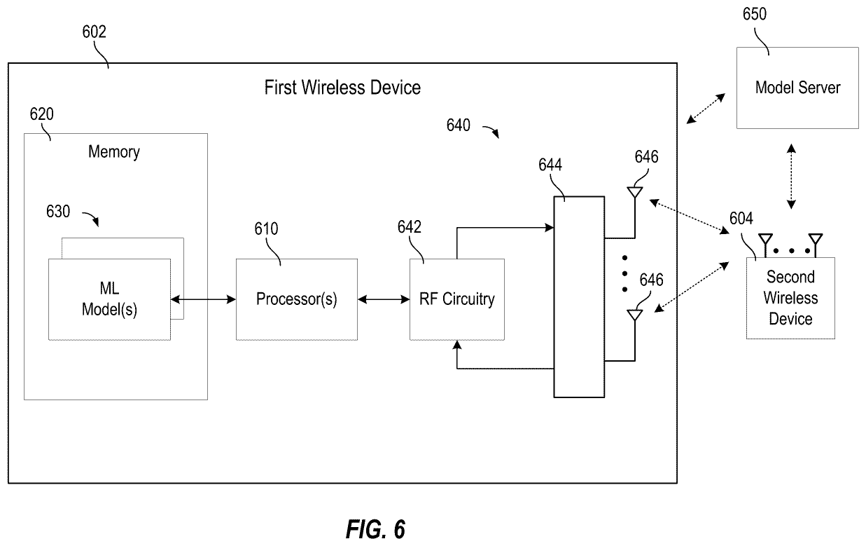

FIG. 6 illustrates an example AI architecture of a first wireless device 602 that is in communication with a second wireless device 604. The first wireless device 602 may be the UE 104 as described herein with respect to FIGS. 1 and 3. Similarly, the second wireless device 604 may be the BS 102 or a disaggregated network entity thereof as described herein with respect to FIGS. 1-3. Note that the AI architecture of the first wireless device 602 may be applied to the second wireless device 604.

The first wireless device 602 may be, or may include, a chip, system on chip (SoC), system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may obtain input data associated with distortion of the RF circuitry 642, and the ML model 630 may provide output data including filter parameters for suppressing the distortion as further described herein with respect to FIGS. 8-14. Note that other input data and/or output data may be used in addition to or instead of the examples described herein.

In certain aspects, the model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized artificial intelligence tasks, such as federated learning.

### Example Artificial Intelligence Model

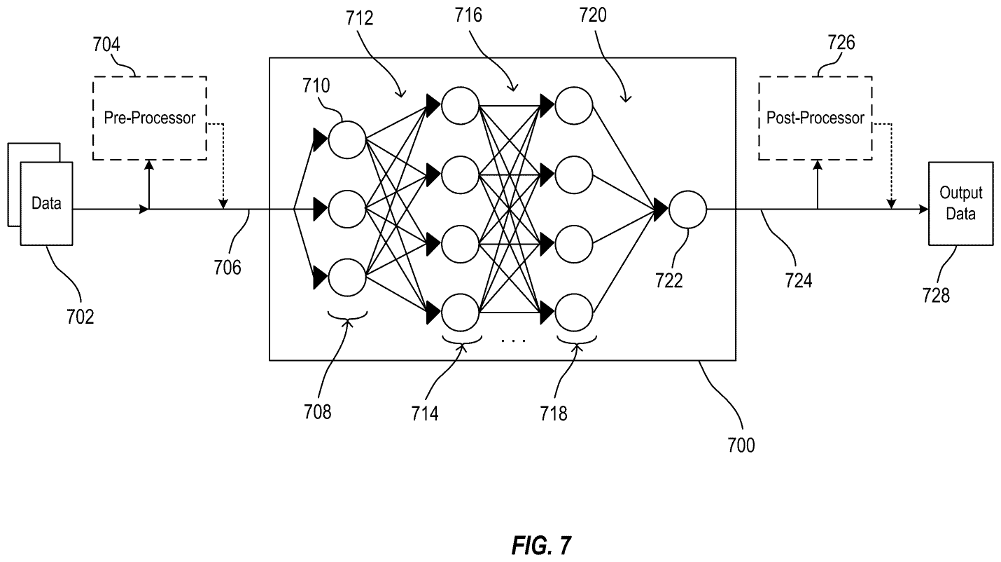

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, tanh, ReLU, and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which may improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Aspects Related to Artificial Intelligence-Based Calibration of Distortion Compensation

Aspects of the present disclosure provide AI-based calibration of distortion compensation for RF chain circuitry.

FIG. 8 illustrates an example receiver architecture 800 that performs distortion compensation, which is calibrated using an AI model as described herein. In this example, the receiver architecture 800 includes one or more antennas 802, an RF front end 804, an amplifier 806, one or more analog filters 808, an analog to digital converter (ADC) 810, one or more processors 812, and one or more memories 814. In certain aspects, the first wireless device 602 of FIG. 6 may include the receiver architecture 800. The cascade of antenna(s) 802, the RF front end 804, the amplifier 806, the one or more analog filters 808, and the ADC 810 may be an example of RF chain circuitry 820. As further described herein, the distortion compensation may be performed via digital signal processing at the processor(s) 812.

The antenna(s) 802 may be an example of the antenna(s) 646 of FIG. 6. The antenna(s) 802 may be coupled to the RF front end 804. RF signals 822 received via the antenna(s) 802 may be processed by the RF front end 804. In certain aspects, the RF signals 822 may be or include a calibration signal having one or more tones 824a-d in a frequency bandwidth 826. In some cases, the calibration signal may be applied to the RF front end 804 via internal calibration circuitry, such as a signal generator or frequency synthesizer. In certain aspects, the tones 824a-d may be overlapping or non-overlapping in time.

As an example, the RF front end 804 may amplify, filter, and/or downconvert the RF signal 822 to a baseband frequency, for example, as described herein with respect to FIG. 6. The RF front end 804 may include, for example, one or more filters, one or more amplifiers, one or more local oscillators, one or more mixers, etc. In certain aspects, the RF front end 804 may demodulate the RF signal into in-phase and quadrature (I/Q) components. For example, the RF front end 804 may split the RF signal (S(t)) via an RF coupler 840 into I/Q signal paths, and mixers 842a, 842b may downconvert the respective RF signal into respective I/Q components (e.g., I(t) and Q(t)) of the baseband signal using a local oscillator 844 as a source of an input frequency for the mixers 842a, 842b.

The RF front end 804 may be coupled to the amplifier 806, which may be or include a low noise amplifier (LNA). The amplifier 806 may output an amplified signal to the one or more analog filters 808, which may be or include a baseband filter. In certain aspects, the analog filter(s) 808 may be or include a low pass filter and/or a bandpass filter. The analog filter(s) 808 may filter the amplified signal to extract a baseband signal. The ADC 810 may convert the baseband signal to a digital signal (e.g., a discrete signal). The ADC 810 may output the digital signal to the processor(s) 812, which may be an example of the processor 610 of FIG. 6. The processor(s) may be coupled to the memory 814, which may be an example of the memory 620.

The processor(s) 812 may perform digital signal processing on the digital baseband signal. For example, the processor(s) 812 may perform direct current (DC) offset cancellation, ADC noise rejection, demapping (e.g., constellation decoding), etc. In certain aspects, the RF chain circuitry 820 may have transfer function imbalances in the modulation signal paths (e.g., the in-phase and quadrature phase signal paths) as described herein, and thus, distortion may be exhibited in the digital baseband signal. In some cases, residual sidebands associated with the I/Q components may form in the digital baseband signal. As an example, a power spectrum 830 of the digital baseband signal has a residual sideband 832 in a negative frequency band. The residual sideband 832 may be an example of distortion caused by an I/Q imbalance of the RF chain circuitry 820.

The processor(s) 812 may perform distortion compensation, for example, using a digital filter 816, which may be or include an FIR filter. The digital filter 816 may be configured to suppress and/or cancel distortion in one or more frequency bandwidths (e.g., the frequency bandwidth 826). For example, the digital filter 816 may be configured based on one or more filter parameters 828. The filter parameters 828 may be or include one or more filter coefficients, a filter operating mode, a total number of filter taps, etc. The digital filter 816 is calibrated using an AI model, for example, as described herein with respect to FIGS. 9A-11.

Note that the receiver architecture 800 is an example of a receiver that performs distortion compensation (e.g., in-phase-quadrature (I/Q) imbalance correction) using the digital filter 816. The distortion compensation and the calibration thereof described herein may be implemented at or in a transmitter, a transceiver, and/or other receiver architectures that exhibit distortion (e.g., I/Q imbalances).

In certain aspects, the distortion compensation for a wireless communications device (e.g., the UE 104 and/or the BS 102) may be calibrated, for example, by measuring the distortion at (or caused by) one or more training tones in one or more frequency bandwidths and configuring a filter that cancels or suppresses the measured distortion. For example, a calibration signal having one or more training tones (e.g., Nₜₒₙₑₛ) in a frequency bandwidth may be received at a receiver (e.g., a receiver having the receiver architecture 800) and/or applied to corresponding RF chain circuitry. In some cases, the training tones in the calibration signal are sent through the RF chain circuitry (e.g., the RF chain circuitry 820) sequentially. The RF chain circuitry outputs a signal corresponding to the calibration signal, where the signal may be indicative of the distortion encountered on the RF chain circuitry 820 for each of the training tones. The processor(s) 812 may accumulate IQ captures associated with the training tones and compute I², Q², and IQ for each of the training tones. The processor(s) 812 may determine the distortion in the digital signal, for example, in terms of a phase error and/or a gain error per training tone.

In certain aspects, the gain error (aₙ) for a training tone (n=1, . . . , Nₜₒₙₑₛ) may be determined based on a method of moments according to the following:

$${a}_{n} = \sqrt{\frac{〈 {Q}^{2} 〉}{〈 {I}^{2} 〉}} \qquad ( 1 )$$

where [symbol] Q² [symbol] is the mean of squared quadrature amplitudes for a given training tone, and [symbol] I² [symbol] is the mean of squared in-phase amplitudes for the respective training tone.

In certain aspects, the phase error (On) for a training tone (n=1, . . . , Nₜₒₙₑₛ) may be determined based on a method of moments according to the following:

$${θ}_{n} = {sin}^{- 1} ( \frac{〈 IQ 〉}{\sqrt{〈 {I}^{2} 〉 〈 {Q}^{2} 〉}} ) \qquad ( 2 )$$

where [symbol] IQ [symbol] is the mean of the I/Q amplitude product for the respective training tone.

FIG. 9A illustrates an example AI model 902 for calibrating or configuring distortion compensation, such as the digital filter 816 of FIG. 8. The AI model 902 may be an example of the ML model(s) 630 of FIG. 6. As shown, the AI model 902 obtains input 904 associated with distortion in a frequency bandwidth and encountered on RF chain circuitry (e.g., the RF chain circuitry 820). The input 904 may include distortion parameters that define the distortion in or associated with the frequency bandwidth (e.g., distortion caused by certain tone(s) in the frequency bandwidth) and/or the target distortion compensation. The input 904 may include the distortion measured at the one or more training tones. For example, the input 904 may include one or more gain errors and/or one or more phase errors associated with one or more training tones (e.g., 4 to 6 tones) in or caused by the training tones in the frequency bandwidth. The gain error(s) and/or phase error(s) may be obtained through measuring the distortion exhibited in a signal output by RF chain circuitry, for example, as discussed above with respect to Equations (1) and (2). In certain aspects, the input 904 may include an indication of the frequency bandwidth and/or the training tones. In some cases, the input 904 may include a performance target for the distortion compensation. For example, the input 904 may include an expected signal quality level (e.g., a target signal-to-noise ratio (SNR)) of the signal output by the distortion compensation (e.g., the filter 816).

The AI model 902 may be trained to predict filter parameters configured to suppress and/or cancel the distortion in the frequency bandwidth. The AI model 902 may provide output 906 that includes certain filter parameters, which may define certain characteristics and/or properties associated with a digital filter (e.g., the filter 816) used to suppress and/or cancel the distortion. For example, the filter parameters may include one or more filter coefficients, a filter operating mode, and/or a total number of filter taps for an FIR filter. The filter operating mode may be or include the sampling rate of the filter, for example, a full sampling rate (e.g. normal mode) or a half sampling rate (e.g., a half-band filtering mode). In some cases, the filter parameters may be configured to satisfy the performance target as provided in the input 904 or within a margin (e.g., ±5%).

As the distortion may be frequency dependent (e.g., frequency dependent residual sideband distortion, residual baseband distortion, and/or residual carrier distortion), the filter parameters may be determined using the AI model 902 for each of multiple frequency bandwidths in a frequency range (e.g., FR1 and/or FR2). For example, first filter parameters for a first frequency bandwidth may be determined using the AI model 902, and second filter parameters for a second frequency bandwidth may be determined using the AI model 902.

FIG. 9B illustrates an example neural network (NN) 920 for calibrating or configuring distortion compensation. The NN 920 may be an example of the AI model 902 of FIG. 9A and/or the ANN 700 of FIG. 7. In this example, the NN 920 may process input data 922 through a pipeline of layers including, for example, an input layer 924, a plurality of hidden layers 926, and an output layer 928. In certain aspects, each of the layers (924, 926, 928) may include a plurality of neurons 930 (e.g., the artificial neurons 710 of FIG. 7) that process input data and provide output data (e.g., one or more extracted features associated with the input data). The neurons 930 may apply an activation function, such as an ELU or any other suitable activation function as described herein.

The input layer 924 obtains the input data 922 (e.g., the input 904 of FIG. 9A) including gain errors 932a-n (GE-1 through GE-N) and phase errors (PE-1 through PE-N) associated with N training tones. The input layer 924 provides output to the hidden layers 926. The hidden layers 926 obtains the output of the input layer 922 and provides output to the output layer 928. The output layer 928 obtains the output of the hidden layers 926 and provides output data 936, such as the output 906 of FIG. 9A. As an example, the output data 936 includes filter coefficients 938a-n for each of the filter taps (e.g., Tap-1 through Tap-N) of an FIR filter (e.g., the filter 816). In certain aspects, the output layer 928 may be a fully connected layer. In some cases, there may be a total of five hidden layers 926.

### Aspects of Training an Artificial Intelligence Model for Calibrating Distortion Compensation

FIG. 10A illustrates example operations 1000 for training an AI model 1008 to calibrate or configure distortion compensation. The operations 1000 may be performed by a model training host (e.g., the model training host 502 of FIG. 5) as further described herein with respect to FIG. 10B. In certain aspects, the AI model 1008 may include the AI model 902 of FIG. 9A and/or the NN 920 of FIG. 9B, and the AI model 1008 may be an example of the ML model(s) described herein with respect to FIG. 5-7.

The model training host obtains training data 1002 including training input data 1004 and corresponding labels 1006 for the training input data 1004. The training input data 1004 may include sets of distortion parameters, for example, as described herein with respect to FIGS. 9A and 9B. The distortion data may be simulated (e.g., computer generated) and/or collected from distortion measurements performed on one or more wireless communications devices (e.g., UEs and/or base stations). The distortion data may include sets of distortion parameters (e.g., gain errors and/or phase errors) associated with one or more frequency bandwidths, for example, different frequency bandwidths in a frequency range (e.g., FR1 and/or FR2). As the distortion may depend on the frequency (e.g., frequency dependent I/Q imbalance including frequency dependent residual sideband distortion), the different frequency bandwidths may enable the AI model 1008 to be trained to suppress or cancel the distortion in multiple frequency bandwidths.

The distortion data may include the distortion parameters measured from various training tones in a frequency bandwidth. In some cases, the distortion data may be measured for more training tones than the total number of tones (e.g., 2, 4, or 6 tones) used to calibrate the distortion compensation. For example, the distortion data for a frequency bandwidth of a wireless device may include distortion parameters associated with ten, fifteen, twenty or more training tones in the frequency bandwidth. In certain aspects, during each iteration of the model training, the model training host may provide, to the AI model 1008, a subset of the distortion parameters measured from the training tones (such as the number training tones that will be used for calibration).

The distortion data may include sets of distortion parameters measured from multiple wireless communications devices. As the distortion may depend on the RF chain circuitry (which may further depend on the specific device), the different wireless devices may enable the AI model 1008 to be trained to suppress or cancel the distortion encountered across various hardware.

The model training host may use the labels 1006 to evaluate the performance of the ML model 1008 and adjust the AI model 1008 (e.g., weights of neurons 930 of FIG. 9B) as further described herein. Each of the labels 1006 may be associated with at least one set of distortion parameters. In certain cases, each of the labels 1006 may include a distortion profile of the frequency bandwidth corresponding to the set of distortion parameters. For example, the distortion profile may include the gain errors and/or phase errors spanning the bandwidth (e.g., 10, 15, 20, or more tones). In some cases, each of the labels 1006 may include the filter parameters that suppress or cancel the distortion for the corresponding frequency bandwidth and the set of distortion parameters in accordance with a target performance. For example, the target performance may be a specified average power and/or peak power of the distortion in a compensated signal (e.g., the signal output by a compensation filter). In certain cases, the target performance may be a specified signal quality of the compensated signal.

The model training host provides the training input data 1004 to the AI model 1008. For example, the model training host may provide a set of distortion parameters to the AI model 1008, where the set of distortion parameters correspond to a specific frequency bandwidth and/or wireless device. As the model training host is training the AI model to predict filter parameters based on a set of training tones used for calibration, the set of distortion parameters may be a subset of the distortion parameters in the training input data for the frequency bandwidth. As discussed above, the training input data may include distortion parameters corresponding to more training tones than the number of training tones used for calibration. The AI model 1008 provides output data 1010, which may include filter parameters as described herein with respect to FIGS. 9A and 9B. For example, the output data 1010 may include filter coefficients and the total number of taps associated with an FIR filter.

At 1012, the model training host determines one or more performance indicators 1016 associated with the output data 1010. The performance indicators 1016 may include an average power of the distortion, a peak power of the distortion, and/or a signal quality (e.g., SNR) associated with a signal output by a filter configured to operate in accordance with the filter parameters predicted by the AI model 1008. In some cases, the model training host may use the distortion profile of the labels 1006 to determine the effect of the filter parameters on the distortion. The model training host may determine the performance of a filter to suppress the distortion associated with the set of distortion parameters provided as input to the AI model 1008. For example, the model training host may determine the average power or peak power of the distortion in the frequency bandwidth of the signal output by the filter operating in accordance with the filter parameters. In some cases, the model training host may determine the signal quality (e.g., SNR) of the signal output by the filter operating in accordance with the filter parameters in the frequency bandwidth associated with the set of distortion parameters provided as input to the AI model 1008. In certain cases, the model training host may determine an image-rejection ratio associated with the distortion.

At 1014, the model training host may evaluate the performance of the output data 1010. For example, the model training host may evaluate the quality and/or accuracy of the output data 1010. The model training host may evaluate a loss function based at least in part on the performance indicator(s) determined at 1012. In certain aspects, the loss function may be, include, or determine the performance indicator(s), for example, an average power of the distortion, a peak power of the distortion, and/or a signal quality of the compensated signal. In certain aspects, the loss function may be or include a difference between the performance indicator(s) and the target performance of the filter parameters. The model training host may adjust the AI model 1008 (e.g., any of the weights in a layer of a neural network) to reduce a loss associated with the AI model 1008. The model training host may continue to provide the training input data 1004 to the AI model 1008 and adjust the AI model 1008 until the loss of the AI model 1008 satisfies a threshold and/or reaches a minimum loss. In certain aspects, the model training host may determine whether the performance of the filter parameters satisfies a target performance (e.g., a specific average power, peak power, and/or a signal quality) or reaches a minimum loss. In certain aspects, the model training host may apply an Adam optimizer to minimize the loss associated with the filter parameters in a frequency bandwidth. In some cases, the model training host may determine whether the output data 1010 matches the corresponding label of the training input data 1004. For example, the model training host may determine whether the predicted filter parameters are correct based on the label (e.g., the expected filter parameters) associated with the set of distortion parameters supplied as input to the AI model 1008.

In certain aspects, the model training host may train the AI model 1008 to satisfy certain criteria associated with the filter parameters. In some cases, the model training host may train the AI model 1008 to use the distortion parameters corresponding to a certain number of training tones (e.g., 2, 4, or 6 training tones). For example, the model training host may set a minimum or maximum number of training tones to be used for obtaining the distortion parameters. In certain cases, the model training host may train the AI model 1008 to predict the filter parameters for a certain number of filter taps. For example, the model training host may set a minimum or maximum number of filter taps for the filter parameters predicted by the AI model 1008.

In certain aspects, the model training host may train multiple AI models. The AI models may be trained with different performance characteristics and/or for different applications (e.g., frequency bandwidths, frequency ranges, wireless devices, etc.). For example, the AI models may be trained to predict filter parameters with different levels of accuracy (e.g., accuracies of 70%, 80%, or 99%) of meeting a performance target, different latencies (e.g., the processing time to predict the filter parameters), and/or different throughputs (e.g., the capacity to predict filter parameters from one or more sets of distortion parameters). In some cases, the model training host may train an AI model for a specific application, for example, based on the frequency bandwidths or frequency ranges. For example, an AI model may be trained to predict filter parameters for a first subset of frequency bandwidths in a frequency range (e.g., FR1 and/or FR2), and another AI model may be trained to predict filter parameters for a second subset of frequency bandwidths in the same frequency range. In some cases, an AI model may be trained to predict filter parameters for the frequency bandwidths in a first frequency range (e.g., FR1), and another AI model may be trained to predict filter parameters for the frequency bandwidths in a second frequency range (e.g., FR2). In some cases, the AI model may be trained to predict the filter parameters for a particular type of wireless device (e.g., particular RF chain circuitry). Thus, the UE may select the AI model that is capable of predicting filter parameters in accordance with certain performance characteristic(s) and/or applications as described above.

FIG. 10B illustrates an example of a model training host 1020 that trains an AI model as described above. As shown, the model training host 1020 includes one or more processors 1022, one or more memories 1024, and one or more communications interfaces 1026. The one or more communications interfaces 1026 may be or include a wired and/or wireless transceiver to communicate data with another device. For example, the model training host 1020 may obtain training input data via the one or more communications interfaces 1026. In some cases, the model training host 1020 may output trained AI model(s) and/or information to reproduce the trained AI model(s) (e.g., model structure, model parameters, and/or model hyper-parameters) via the one or more communications interfaces 1026. The one or more processors 1022 are coupled to the one or more memories 1024 and the one or more communications interfaces 1026, which may be coupled to the one or more memories 1024. The one or more memories store instructions (e.g., processor-executable instructions) that when executed by the one or more processors 1022, cause the model training host 1020 to perform the training operations described herein with respect to FIG. 10A.

In certain aspects, the model training host 1020 may be or include a UE (e.g., the UE 104), a network entity (e.g., the BS 102), and/or a computing device. The computing device may be or include a server, a computer (e.g., a laptop computer, a tablet computer, a personal computer (PC), a desktop computer, etc.), a virtual device, or any other electronic device or computing system capable of performing model training as described herein. In certain aspects, the model training host 1020 may be or include a base station (e.g., the BS 102), a disaggregated entity thereof (e.g., CU 210, DU 230, and/or RU 240), a network entity of a core network (e.g., the 5GC 190), and/or a network entity of a cloud-based RAN (e.g., Near-RT RICs 225, the Non-RT RICs 215, and/or the SMO Framework 205 of FIG. 2).

### Aspects of Calibrating Distortion Compensation Using Multiple Neural Networks

FIG. 11 illustrates example operations 1100 for calibrating or configuring distortion compensation using multiple neural networks including a first neural network 1104 and a second neural network 1106. The operations 1100 may be performed by a model inference host (e.g., the model inference host 504 of FIG. 5) and/or a model training host (e.g., the model training host 502 of FIG. 5). In some cases, the model inference host and/or the model training host may be or include a UE (e.g., the UE 104), a network entity (e.g., the BS 102), and/or a computing device.

In this example, the first neural network 1104 may be trained to predict certain training tone locations (e.g., frequency locations) in a frequency bandwidth for a calibration signal. For example, the predicted training tone locations may cause a specified distortion response, such as the strongest distortion (e.g., highest power) or a weakest signal quality (e.g., SNR) in the output signal of the RF chain circuitry. In some cases, the predicted training tone locations may cause a weakest distortion or a strongest signal quality. In certain cases, the predicted training tone locations may cause a suitable estimate of the distortion from the number of training tones used for calibration (e.g., 2, 4, or 6). The first neural network 1104 may obtain input data 1102, which may include the distortion parameters across a frequency bandwidth, for example, as described herein with respect to FIGS. 9A and 9B. The first neural network 1104 may output training tone locations that provide a representative distortion profile from a certain number of training tones in a calibration signal. The predicted training tone locations may enable efficient calibration of the distortion compensation, for example, through a reduced calibration time and/or improved compensation performance. The training tone locations may be used to generate a calibration signal sent through RF chain circuitry and measure the distortion of the RF chain circuitry.

The second neural network 1106 may be an example of the AI models described herein with respect to FIGS. 9A and 10A and an example of the neural network described herein with respect to FIG. 9B. In certain aspects, the predicted training tone locations may be used to train the second neural network 1106, for example, as described herein with respect to FIG. 10A. The second neural network 1106 may provide output data 1108, which may be an example of the output data 1010. At 1110 and 1112, a model training host may perform the operations at 1012 and 1014 as described herein with respect to FIG. 10A. In this example, the model training host may adjust the first neural network 1104 (e.g., the weights or coefficients) in response to the performance indicator(s) not satisfying a performance target and/or reaching a minimum loss.

Aspects of Manufacturing a Wireless Device with Distortion Compensation

FIG. 12 illustrates example operations 1200 for manufacturing a wireless communications device calibrated to perform distortion compensation as described herein with respect to FIGS. 8-11. The operations 1200 may be performed at a manufacturing facility, for example, using RF calibration equipment.

At 1202, a wireless communications device may be assembled. In certain aspects, RF chain circuitry 1206 may be coupled to one or more processors 1208 via one or more circuit boards. The RF chain circuitry 1206 may be an example of the transceiver 640 and/or the RF chain circuitry 820. The one or more processors 1208 may be an example of the processor 610 and/or the processor(s) 812. In some cases, one or more memories 1210 may be coupled to the one or more processors 1208, for example, via the one or more circuit boards.

At 1204, the assembled wireless communications device 1212 may be obtained. The wireless communications device 1212 may be an example of a UE (e.g., the UE 104) and/or a base station (e.g., the BS 102 and/or the RU 240).

At 1206, the wireless communications device 1212 may be calibrated. The wireless communications device 1212 may perform the calibration of distortion compensation as described herein with respect to FIGS. 8-11. The wireless communications device 1212 may measure the distortion output from RF chain circuitry and provide certain distortion parameters to an AI model (e.g., the AI model 902), for example, as described herein with respect to FIG. 9A. The AI model provides filter parameters configured to suppress or cancel the distortion, and the wireless communications device 1212 stores the filter parameters in memory. For wireless communications, the wireless communications device 1212 performs the distortion compensation, for example, using a digital filter in accordance with the filter parameters associated with the particular frequency bandwidth.

In some cases, the wireless communications device 1212 may perform self-calibration, where the wireless communications device 1212 generates the calibration signal and measures the distortion on the transmit chain or receive chain of RF chain circuitry. As an example, for receive chain calibration, the wireless communications device 1212 may generate a calibration signal 1216 having one or more training tones and inject the calibration signal into a receive chain (e.g., the RF chain circuitry 820). For transmit chain calibration, the wireless communications device 1212 may selectively couple a transmit chain (e.g., at an antenna feed of the transmit chain) to a receive feedback chain. In some cases, the wireless communications device 1212 may output a calibration signal via a transmit chain and receive the calibration signal on a receive chain for receive chain calibration and/or transmit chain calibration. The wireless communications device may measure the distortion of the RF chain circuitry, for example, as described herein with respect to FIG. 8.

In certain aspect, a calibration transceiver 1214 may be used to calibrate the wireless communications device 1212. For receive chain calibration, the calibration transceiver 1214 may transmit, to the wireless communications device 1212, the calibration signal 1216 having one or more training tones in a frequency bandwidth. The wireless communications device may measure the distortion of the RF chain circuitry, for example, as described herein with respect to FIG. 8. For transmit chain calibration, the calibration transceiver 1214 may receive, from the wireless communications device 1212, the calibration signal 1216 having one or more training tones in the frequency bandwidth, and the calibration transceiver 1214 may measure the distortion affecting the transmitted calibration signal.

### Example Operations

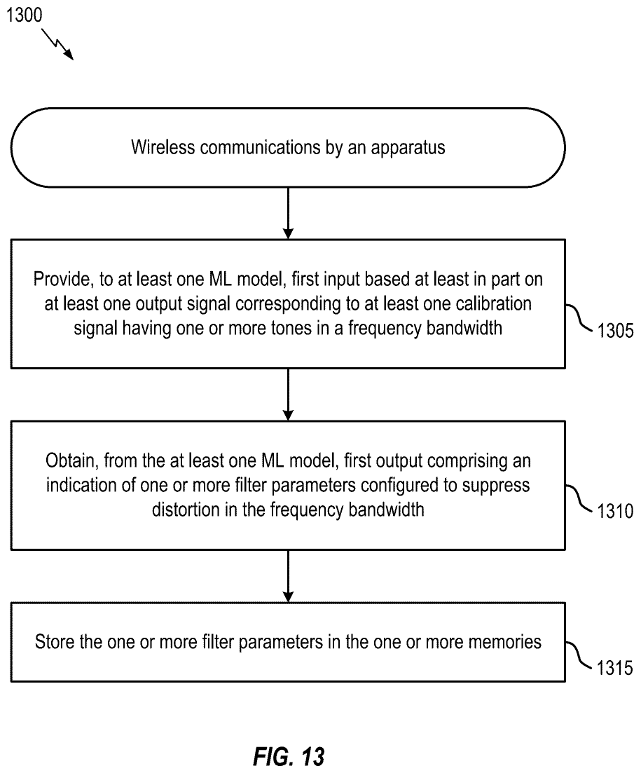

FIG. 13 shows a method 1300 for wireless communications by an apparatus, such as UE 104 of FIGS. 1 and 3.

Method 1300 begins at block 1305 with providing, to at least one AI model, first input based at least in part on at least one output signal corresponding to at least one calibration signal having one or more tones in a frequency bandwidth. In certain aspects, the first input comprises: a gain error associated with at least one of the one or more tones; a phase error associated with at least one of the one or more tones; or a combination thereof.

Method 1300 then proceeds to block 1310 with obtaining, from the at least one AI model, first output comprising an indication of one or more filter parameters configured to suppress distortion in the frequency bandwidth. In certain aspects, the one or more filter parameters comprises: one or more filter coefficients; a filter operating mode (e.g., a full sampling mode or a half sampling mode); a total number of filter taps; or a combination thereof.

Method 1300 then proceeds to block 1315 with storing the one or more filter parameters in one or more memories (e.g., the memory 620 of FIG. 6 or the memory 814 of FIG. 8).

In certain aspects, method 1300 further includes communicating at least one signal using RF chain circuitry of the apparatus. In certain aspects, method 1300 further includes sending, through the RF chain circuitry, the at least one calibration signal. In certain aspects, method 1300 further includes obtaining, from the RF chain circuitry, the at least one output signal. In certain aspects, method 1300 further includes filtering one or more communication signals using a filter (e.g., the filter 816) configured to operate in accordance with the one or more filter parameters. In certain aspects, the distortion is associated with the RF chain circuitry. In certain aspects, the distortion comprises one or more residual sidebands attributable to at least an in-phase-quadrature imbalance in the RF chain circuitry.

In certain aspects, the filter comprises a digital filter configured to filter samples associated with the one or more communication signals. In certain aspects, the digital filter comprises a FIR filter having a plurality of filter taps.

In certain aspects, the at least one AI model comprises a neural network (e.g., the NN 920) comprising: a plurality of hidden layers (e.g., the hidden layers 926); and at least one activation function comprising an exponential linear unit (ELU).

In certain aspects, method 1300 further includes training the at least one AI model using at least a loss function based at least in part on a performance indicator of the one or more filter parameters, for example, as described herein with respect to FIG. 10A. In certain aspects, the performance indicator of the one or more filter parameters comprises a metric of the distortion in the frequency bandwidth allowed to pass through a filter configured to operate in accordance with the one or more filter parameters. In certain aspects, the performance indicator of the one or more filter parameters comprises: an average power of a residual sideband in the frequency bandwidth of the at least one output signal; a peak power of a residual sideband in the frequency bandwidth of the at least one output signal; a signal quality associated with the at least one calibration signal; or a combination thereof.

In certain aspects, training the AI model comprises training the at least one AI model to satisfy one or more criteria associated with the one or more filter parameters. In certain aspects, the one or more criteria comprises: a first limit for the one or more tones; a second limit for a total number of filter taps; or a combination thereof.

In certain aspects, a total number of the one or more tones comprises at least two tones. In some cases, the total number of the one or more tones comprises one tone to six tones; one tone to ten tones; or one tone to twenty tones. The AI-based calibration described herein may enable a reduced number of tones (e.g., two tones) used for calibrating the filter parameters. The AI-based calibration described herein may enable the prediction of filter parameters that suppress or cancel distortion over the frequency bandwidth using a few calibration tones (e.g., 2, 4, or 6 tones). For example, the filter parameters may minimize an average distortion across the frequency bandwidth, and thus, the filter parameters may suppress or cancel distortion at frequency location(s) outside of the calibration tones (e.g., the one or more tones).

In certain aspects, the at least one AI model comprises a first AI model and a second AI model, for example, as described herein with respect to FIG. 11. In certain aspects, block 1305 includes providing, to the first AI model, the first input; block 1310 includes obtaining, from the second AI model, the first output; and the method 1300 further comprises: obtaining, from the first AI model, second output comprising an indication of the one or more tones, and providing, to the second AI model, second input comprising the indication of the one or more tones and the first input.

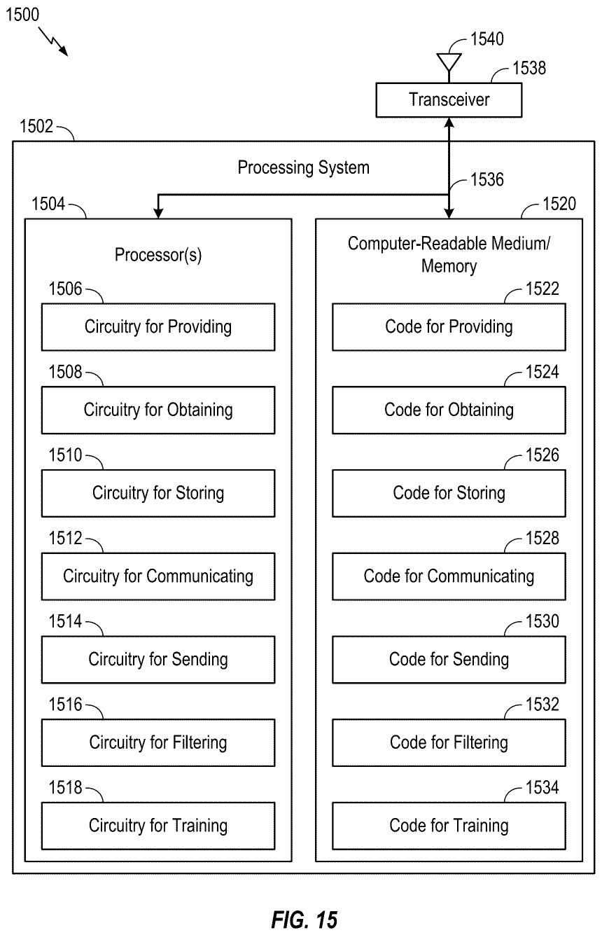

In certain aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure.

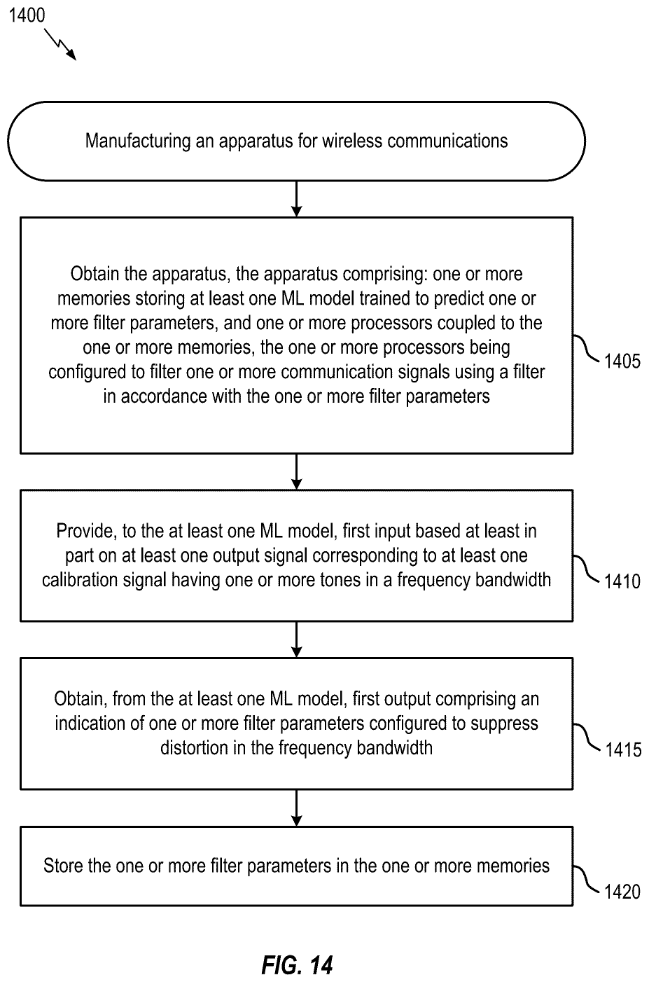

FIG. 14 shows a method 1400 for manufacturing a wireless communications device, such as UE 104 and/or BS 102 of FIGS. 1 and 3.

Method 1400 begins at block 1405 with obtaining the apparatus, for example, as described herein with respect to FIG. 12. The apparatus comprises: one or more memories storing at least one AI model trained to predict one or more filter parameters, and one or more processors being coupled to the one or more memories, the one or more processors configured to filter one or more communication signals using a filter (e.g., the filter 816) in accordance with the one or more filter parameters. In certain aspects, the filter comprises a digital filter configured to filter samples associated with the one or more communication signals. In certain aspects, the digital filter comprises a FIR filter having a plurality of filter taps. In certain aspects, the at least one AI model comprises a neural network comprising: a plurality of hidden layers; and at least one activation function comprising an exponential linear unit.

Method 1400 then proceeds to block 1410 with providing, to the at least one AI model, first input based at least in part on at least one output signal corresponding to at least one calibration signal having one or more tones in a frequency bandwidth. In certain aspects, the first input comprises: a gain error associated with at least one of the one or more tones; a phase error associated with at least one of the one or more tones; or a combination thereof.

Method 1400 then proceeds to block 1415 with obtaining, from the at least one AI model, first output comprising an indication of one or more filter parameters configured to suppress distortion in the frequency bandwidth. In certain aspects, the one or more filter parameters comprises: one or more filter coefficients; a filter operating mode; a total number of filter taps; or a combination thereof.

Method 1400 then proceeds to block 1420 with storing the one or more filter parameters in the one or more memories.

In certain aspects, obtaining the apparatus comprises coupling the RF chain circuitry to the one or more processors, for example, via one or more circuit boards.

In certain aspects, the apparatus further comprises a RF chain circuitry configured to communicate at least one signal, wherein the method further comprises: sending, through the RF chain circuitry, the at least one calibration signal; and obtaining, from the RF chain circuitry, the at least one output signal. In certain aspects, the distortion is associated with the RF chain circuitry. In certain aspects, the distortion comprises one or more residual sidebands attributable to at least an in-phase-quadrature imbalance in the RF chain circuitry.

Note that FIG. 14 is just one example of a method, and other methods including fewer, additional, or alternative operations are possible consistent with this disclosure.

### Example Communications Devices

FIG. 15 depicts aspects of an example communications device 1500. In some aspects, communications device 1500 is a user equipment, such as UE 104 described above with respect to FIGS. 1 and 3.

The communications device 1500 includes a processing system 1502 coupled to a transceiver 1538 (e.g., a transmitter and/or a receiver). The transceiver 1538 is configured to transmit and receive signals for the communications device 1500 via an antenna 1540, such as the various signals as described herein. The processing system 1502 may be configured to perform processing functions for the communications device 1500, including processing signals received and/or to be transmitted by the communications device 1500.

The processing system 1502 includes one or more processors 1504. In various aspects, the one or more processors 1504 may be representative of one or more of receive processor 358, transmit processor 364, TX MIMO processor 366, and/or controller/processor 380, as described with respect to FIG. 3. The one or more processors 1504 are coupled to a computer-readable medium/memory 1520 via a bus 1536. In certain aspects, the computer-readable medium/memory 1520 is configured to store instructions (e.g., computer-executable code) that when executed by the one or more processors 1504, enable and cause the one or more processors 1504 to perform the method 1300 described with respect to FIG. 13, or any aspect related to it, including any additional steps or sub-steps described in relation to FIG. 13. Note that reference to a processor performing a function of communications device 1500 may include one or more processors performing that function of communications device 1500, such as in a distributed fashion.

In the depicted example, computer-readable medium/memory 1520 stores code for providing 1522, code for obtaining 1524, code for storing 1526, code for communicating 1528, code for sending 1530, code for filtering 1532, and code for training 1534. Processing of the code 1522-1534 may enable and cause the communications device 1500 to perform the method 1300 described with respect to FIG. 13, or any aspect related to it.

The one or more processors 1504 include circuitry configured to implement (e.g., execute) the code stored in the computer-readable medium/memory 1520, including circuitry for providing 1506, circuitry for obtaining 1508, circuitry for storing 1510, circuitry for communicating 1512, circuitry for sending 1514, circuitry for filtering 1516, and circuitry for training 1518. Processing with circuitry 1506-1518 may enable and cause the communications device 1500 to perform the method 1300 described with respect to FIG. 13, or any aspect related to it.

More generally, means for communicating, transmitting, sending, providing, or outputting for transmission may include the transceivers 354, antenna(s) 352, transmit processor 364, TX MIMO processor 366, and/or controller/processor 380 of the UE 104 illustrated in FIG. 3, transceiver 1538 and/or antenna 1540 of the communications device 1500 in FIG. 15, and/or one or more processors 1504 of the communications device 1500 in FIG. 15. Means for communicating, receiving, or obtaining may include the transceivers 354, antenna(s) 352, receive processor 358, and/or controller/processor 380 of the UE 104 illustrated in FIG. 3, transceiver 1538 and/or antenna 1540 of the communications device 1500 in FIG. 15, and/or one or more processors 1504 of the communications device 1500 in FIG. 15. Means for storing, filtering, or training may include the controller/processor 380 of the UE 104 illustrated in FIG. 3, and/or one or more processors 1504 of the communications device 1500 in FIG. 15.

### Example Clauses

Implementation examples are described in the following numbered clauses:

Clause 1: A method for wireless communications by an apparatus comprising: providing, to at least one AI model, first input based at least in part on at least one output signal corresponding to at least one calibration signal having one or more tones in a frequency bandwidth; obtaining, from the at least one AI model, first output comprising an indication of one or more filter parameters configured to suppress distortion in the frequency bandwidth; and storing the one or more filter parameters in one or more memories.

Clause 2: The method of Clause 1, further comprising: communicating at least one signal using RF chain circuitry of the apparatus; sending, through the RF chain circuitry, the at least one calibration signal; obtaining, from the RF chain circuitry, the at least one output signal; and filtering one or more communication signals using a filter configured to operate in accordance with the one or more filter parameters.

Clause 3: The method of Clause 2, wherein the distortion is associated with the RF chain circuitry.

Clause 4: The method of Clause 2 or 3, wherein the filter comprises a digital filter configured to filter samples associated with the one or more communication signals.

Clause 5: The method of Clause 4, wherein the digital filter comprises a FIR filter having a plurality of filter taps.

Clause 6: The method of any of Clauses 2-5, wherein the distortion comprises one or more residual sidebands attributable to at least an in-phase-quadrature imbalance in the RF chain circuitry.

Clause 7: The method of any of Clauses 1-6, wherein the first input comprises: a gain error associated with at least one of the one or more tones; a phase error associated with at least one of the one or more tones; or a combination thereof.

Clause 8: The method of any of Clauses 1-7, wherein the at least one AI model comprises a neural network comprising: a plurality of hidden layers; and at least one activation function comprising an exponential linear unit.

Clause 9: The method of any of Clauses 1-8, wherein the one or more filter parameters comprises: one or more filter coefficients; a filter operating mode; a total number of filter taps; or a combination thereof.

Clause 10: The method of any of Clauses 1-9, further comprising and training the at least one AI model using at least a loss function based at least in part on a performance indicator of the one or more filter parameters.

Clause 11: The method of Clause 10, wherein the performance indicator of the one or more filter parameters comprises a metric of the distortion in the frequency bandwidth allowed to pass through a filter configured to operate in accordance with the one or more filter parameters.

Clause 12: The method of Clause 10 or 11, wherein the performance indicator of the one or more filter parameters comprises: an average power of a residual sideband in the frequency bandwidth of the at least one output signal; a peak power of a residual sideband in the frequency bandwidth of the at least one output signal; a signal quality associated with the at least one calibration signal; or a combination thereof.

Clause 13: The method of any of Clauses 10-12, wherein training the AI model comprises training the at least one AI model to satisfy one or more criteria associated with the one or more filter parameters.

Clause 14: The method of Clause 13, wherein the one or more criteria comprises: a first limit for the one or more tones; a second limit for a total number of filter taps; or a combination thereof.

Clause 15: The method of any of Clauses 1-14, wherein a total number of the one or more tones comprises at least two tones or one tone to six tones.

Clause 16: The method of any of Clauses 1-15, wherein: the at least one AI model comprises a first AI model and a second AI model; providing the first input comprises providing, to the first AI model, the first input; and obtaining the first output comprises obtaining, from the second AI model, the first output.

Clause 17: The method of Clause 16, further comprising: obtaining, from the first AI model, second output comprising an indication of the one or more tones; and providing, to the second AI model, second input comprising the indication of the one or more tones and the first input.

Clause 18: A method of manufacturing an apparatus for wireless communications, comprising: obtaining the apparatus, the apparatus comprising: one or more memories storing at least one AI model trained to predict one or more filter parameters, and one or more processors coupled to the one or more memories, the one or more processors being configured to filter one or more communication signals using a filter in accordance with the one or more filter parameters; providing, to the at least one AI model, first input based at least in part on at least one output signal corresponding to at least one calibration signal having one or more tones in a frequency bandwidth; obtaining, from the at least one AI model, first output comprising an indication of one or more filter parameters configured to suppress distortion in the frequency bandwidth; and storing the one or more filter parameters in the one or more memories.

Clause 19: The method of Clause 18, wherein the apparatus further comprises a RF chain circuitry configured to communicate at least one signal, wherein the method further comprises: sending, through the RF chain circuitry, the at least one calibration signal; and obtaining, from the RF chain circuitry, the at least one output signal.

Clause 20: The method of Clause 19, wherein obtaining the apparatus comprises coupling the RF chain circuitry to the one or more processors.

Clause 21: The method of Clause 19 or 20, wherein the distortion is associated with the RF chain circuitry.

Clause 22: The method of any of Clauses 19-21, wherein the filter comprises a digital filter configured to filter samples associated with the one or more communication signals.

Clause 23: The method of Clause 22, wherein the digital filter comprises a FIR filter having a plurality of filter taps.

Clause 24: The method of any of Clauses 19-23, wherein the distortion comprises one or more residual sidebands attributable to at least an in-phase-quadrature imbalance in the RF chain circuitry.

Clause 25: The method of any of Clauses 18-24, wherein the first input comprises: a gain error associated with at least one of the one or more tones; a phase error associated with at least one of the one or more tones; or a combination thereof.

Clause 26: The method of any of Clauses 18-25, wherein the at least one AI model comprises a neural network comprising: a plurality of hidden layers; and at least one activation function comprising an exponential linear unit.

Clause 27: The method of any of Clauses 18-26, wherein the one or more filter parameters comprises: one or more filter coefficients; a filter operating mode; a total number of filter taps; or a combination thereof.

Clause 28: One or more apparatuses, comprising: one or more memories comprising executable instructions; and one or more processors configured to execute the executable instructions and cause the one or more apparatuses to perform a method in accordance with any of Clauses 1-27.

Clause 29: One or more apparatuses, comprising: one or more memories; and one or more processors coupled to the one or memories, the one or more processors being configured to cause the one or more apparatuses to perform a method in accordance with any of Clauses 1-27.

Clause 30: One or more apparatuses, comprising means for performing a method in accordance with any of Clauses 1-27.

Clause 31: One or more non-transitory computer-readable media comprising executable instructions that, when executed by one or more processors of one or more apparatuses, cause the one or more apparatuses to perform a method in accordance with any of Clauses 1-27.

Clause 32: One or more computer program products embodied on one or more computer-readable storage media comprising code for performing a method in accordance with any of Clauses 1-27.

Clause 33: A user equipment (UE) comprising: a processing system that includes processor circuitry and memory circuitry that stores code and is coupled with the processor circuitry, the processing system configured to cause the UE to perform a method in accordance with any of Clauses 1-27.

Clause 34: A network entity comprising: a processing system that includes processor circuitry and memory circuitry that stores code and is coupled with the processor circuitry, the processing system configured to cause the network entity to perform a method in accordance with any of Clauses 1-27.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications at a wireless device, comprising:
one or more memories; and
one or more processors coupled to the one or more memories, the one or more processors being configured to cause the wireless device to:
provide, to at least one artificial intelligence (AI) model, first input based at least in part on at least one output signal corresponding to at least one calibration signal having one or more tones in a frequency bandwidth;
obtain, from the at least one AI model, first output comprising an indication of one or more filter parameters configured to suppress distortion in the frequency bandwidth; and
store the one or more filter parameters in the one or more memories.

2. The apparatus of claim 1, further comprising:
radio frequency (RF) chain circuitry configured to communicate at least one signal, wherein the one or more processors are configured to cause the wireless device to:
send, through the RF chain circuitry, the at least one calibration signal;
obtain, from the RF chain circuitry, the at least one output signal; and
filter one or more communication signals using a filter configured to operate in accordance with the one or more filter parameters.

3. The apparatus of claim 2, wherein the distortion is associated with the RF chain circuitry.

4. The apparatus of claim 2, wherein the filter comprises a digital filter configured to filter samples associated with the one or more communication signals.

5. The apparatus of claim 4, wherein the digital filter comprises a finite impulse response (FIR) filter having a plurality of filter taps.

6. The apparatus of claim 2, wherein the distortion comprises one or more residual sidebands attributable to at least an in-phase-quadrature imbalance in the RF chain circuitry.

7. The apparatus of claim 1, wherein the first input comprises:
a gain error associated with at least one of the one or more tones;
a phase error associated with at least one of the one or more tones; or
a combination thereof.

8. The apparatus of claim 1, wherein the at least one AI model comprises a neural network comprising:
a plurality of hidden layers; and
at least one activation function comprising an exponential linear unit.

9. The apparatus of claim 1, wherein the one or more filter parameters comprises:
one or more filter coefficients;
a filter operating mode;
a total number of filter taps; or
a combination thereof.

10. The apparatus of claim 1, wherein the one or more processors are configured to cause the wireless device to train the at least one AI model using at least a loss function based at least in part on a performance indicator of the one or more filter parameters.

11. The apparatus of claim 10, wherein the performance indicator of the one or more filter parameters comprises a metric of the distortion in the frequency bandwidth allowed to pass through a filter configured to operate in accordance with the one or more filter parameters.

12. The apparatus of claim 10, wherein the performance indicator of the one or more filter parameters comprises:
an average power of a residual sideband in the frequency bandwidth of the at least one output signal;
a peak power of a residual sideband in the frequency bandwidth of the at least one output signal;
a signal quality associated with the at least one calibration signal; or
a combination thereof.

13. The apparatus of claim 10, wherein to train the AI model, the one or more processors are configured to cause the wireless device to train the at least one AI model to satisfy one or more criteria associated with the one or more filter parameters.

14. The apparatus of claim 13, wherein the one or more criteria comprises:
a first limit for the one or more tones;
a second limit for a total number of filter taps; or
a combination thereof.

15. The apparatus of claim 1, wherein a total number of the one or more tones comprises at least two tones.

16. The apparatus of claim 1, wherein:
the at least one AI model comprises a first AI model and a second AI model;
to provide the first input, the one or more processors are configured to cause the wireless device to provide, to the first AI model, the first input;
to obtain the first output, the one or more processors are configured to cause the apparatus to obtain, from the second AI model, the first output; and
the one or more processors are configured to cause the wireless device to:
obtain, from the first AI model, second output comprising an indication of the one or more tones, and
provide, to the second AI model, second input comprising the indication of the one or more tones and the first input.

17. A method for wireless communications at a wireless device, comprising:
providing, to at least one artificial intelligence (AI) model, first input based at least in part on at least one output signal corresponding to at least one calibration signal having one or more tones in a frequency bandwidth;
obtaining, from the at least one AI model, first output comprising an indication of one or more filter parameters configured to suppress distortion in the frequency bandwidth; and
storing the one or more filter parameters in one or more memories.

18. A non-transitory computer-readable medium storing instructions, which when executed by one or more processors of an apparatus, cause the apparatus to perform operations comprising:
providing, to at least one artificial intelligence (AI) model, first input based at least in part on at least one output signal corresponding to at least one calibration signal having one or more tones in a frequency bandwidth;
obtaining, from the at least one AI model, first output comprising an indication of one or more filter parameters configured to suppress distortion in the frequency bandwidth; and
storing the one or more filter parameters in one or more memories.

19. A method of manufacturing an apparatus for wireless communications, comprising:
obtaining the apparatus, the apparatus comprising:
one or more memories storing at least one artificial intelligence (AI) model trained to predict one or more filter parameters, and
one or more processors coupled to the one or more memories, the one or more processors configured to filter one or more communication signals using a filter in accordance with the one or more filter parameters;
providing, to the at least one AI model, first input based at least in part on at least one output signal corresponding to at least one calibration signal having one or more tones in a frequency bandwidth;
obtaining, from the at least one AI model, first output comprising an indication of one or more filter parameters configured to suppress distortion in the frequency bandwidth; and
storing the one or more filter parameters in the one or more memories.

20. The method of claim 19, wherein:
the apparatus further comprises a radio frequency (RF) chain circuitry configured to communicate at least one signal; and
the method further comprises:
sending, through the RF chain circuitry, the at least one calibration signal; and
obtaining, from the RF chain circuitry, the at least one output signal.

21. The method of claim 20, wherein obtaining the apparatus comprises coupling the RF chain circuitry to the one or more processors.

22. The method of claim 20, wherein the distortion is associated with the RF chain circuitry.

23. The method of claim 20, wherein the filter comprises a digital filter configured to filter samples associated with the one or more communication signals.

24. The method of claim 23, wherein the digital filter comprises a finite impulse response (FIR) filter having a plurality of filter taps.

25. The method of claim 20, wherein the distortion comprises one or more residual sidebands attributable to at least an in-phase-quadrature imbalance in the RF chain circuitry.

26. The method of claim 19, wherein the first input comprises:
a gain error associated with at least one of the one or more tones;
a phase error associated with at least one of the one or more tones; or
a combination thereof.

27. The method of claim 19, wherein the at least one AI model comprises a neural network comprising:
a plurality of hidden layers; and
at least one activation function comprising an exponential linear unit.

28. The method of claim 19, wherein the one or more filter parameters comprises:
one or more filter coefficients;
a filter operating mode;
a total number of filter taps; or
a combination thereof.
